(19) United States
(12) Patent Application Publication
(10) Pub. No.: US 2011/0048362 A1
(43) Pub. Date: Mar. 3, 2011

(54) Internal conbustion engine

(76) Inventor: Yakiv Cherkasky, Koblenz (DE)

(21) Appl. No.: 12/319,810

(22) Filed: Jan. 13, 2009

(30) Foreign Application Priority Data
Jun. 9, 2008 (DE) 10 2008 028 188.3

(51) Int. Cl. F02F 3/00

(52) U.S. Cl. 123/193.4

(57) ABSTRACT

An internal-combustion engine comprised of a cylinder with at least one piston which is moving to and fro in it, and a piston rod (6), which transforms the piston's movement to rotary motion in a crank shaft (9), and including equipment for a forcible stabilization of the piston axle. Each small end of the piston rods has an additional part (6g) at its right side, to produce an additional torsional moment with the aid of inertial forces. This part is characterized by its optimized form; the piston rod's big end (6f) includes the additional parts (6m), (6n), also at its right side; In this way, the force vectors and the torsional moment of the motor are optimized due to the effect of the inertial forces and the mass of the entire piston rod may be used to increase the inertial forces, which results in a considerable improvement of the economic and ecological properties of internal-combustion engines and other piston engines.

The invention increases the effective pressure in internal-combustion engines, optimizes their economic and ecological properties by realizing the reserves of their crank mechanisms with the aid of the inertial forces, caused by the additional parts to the right of the small and big ends of the piston rods; furthermore, the ease of installation of the stabilizing element of the piston axle is improved due to the inclined configuration of the special screw.

### STATE OF THE TECHNOLOGY

In traditional internal-combustion engines, at the beginning of the working stroke, when the pressure of the gases in the cylinder is at its maximum, the torque of the crank shaft at this moment of maximum force is null, because the piston rod and the crank are in one straight line. The piston swings in the piston pin within the boundaries of the necessary warm-up movement of the assembly, which causes a certain overflow, and, hence, inevitably reduces compression. Furthermore, the pistons have an excessive length, and, hence, an excessive mass, as the main function is accomplished by the piston skirts. This results in an increase of internal, inertial back pressure. The above-mentioned losses reduce the effective pressure and, correspondingly, the degree of efficiency.

In the internal-combustion engine as per file number 10 2007 027 202.4, the above-mentioned losses are substantially reduced. For this purpose, it includes the additional part (6a) at the right upper end of the piston rod. At the moment that the piston leaves the top dead centre and at the beginning of the working stroke, and its downward movement, an inertial force develops, which causes a counterclockwise torque to the piston rod. Therefore, when the piston rod makes contact with the crank, a force appears, causing a clockwise torsional moment. Such torsional moments caused by inertial forces appear in all working cycles of the motor and they produce a considerable increase of the crank shaft's torque, which boosts the effective pressure in the cylinder. The increase is a result of the optimized arrangement of the force vectors during the motor's work and it substantially improves the motor's efficiency factor. The efficiency of the inertial forces is determined by the value of the torsional moment.

Also, the losses may be minimized by a forced stabilization of the piston axle with the aid of the guide rail and the guide beam.

An analysis of the internal-combustion engine's design as per invention reference number 10 2008 027 202.4, however, reveals that not all reserves of the crank mechanism have been realized.

### AIM OF THE INVENTION

Thus, the aim of the invention is the creation of an internal-combustion engine with improved economic and ecological parameters by way of optimizing the value and configuration of the inertial force vectors in the motor's crank mechanism.

This aim is achieved by applying the additional part in a sectional area through the piston axle, preferably in the form of a trapezium; the part nudges the small end of the piston rod, and due to its small base area, the gap between the centers of gravity of the additional part and the axis of the piston pin, and, consequently, between the values of the inertial force moment and the torque moment of the motor, respectively, is increased; the big ends of the piston rods are also equipped with the additional parts; therefore, the inertial force of the mass of the entire piston rod is used to increase the additional torsional moment due to a shift of its centre of gravity to the right of the piston axle; the axle of the special screw for attaching the beam to the guide slot of the piston's guide rail is on the lower part of the cylinder with an inclination to improve the cylinder's ease of installation to the periphery.

### DESCRIPTION OF THE INVENTION

The invention is explained below based on demonstrated working examples.

The figures depict:

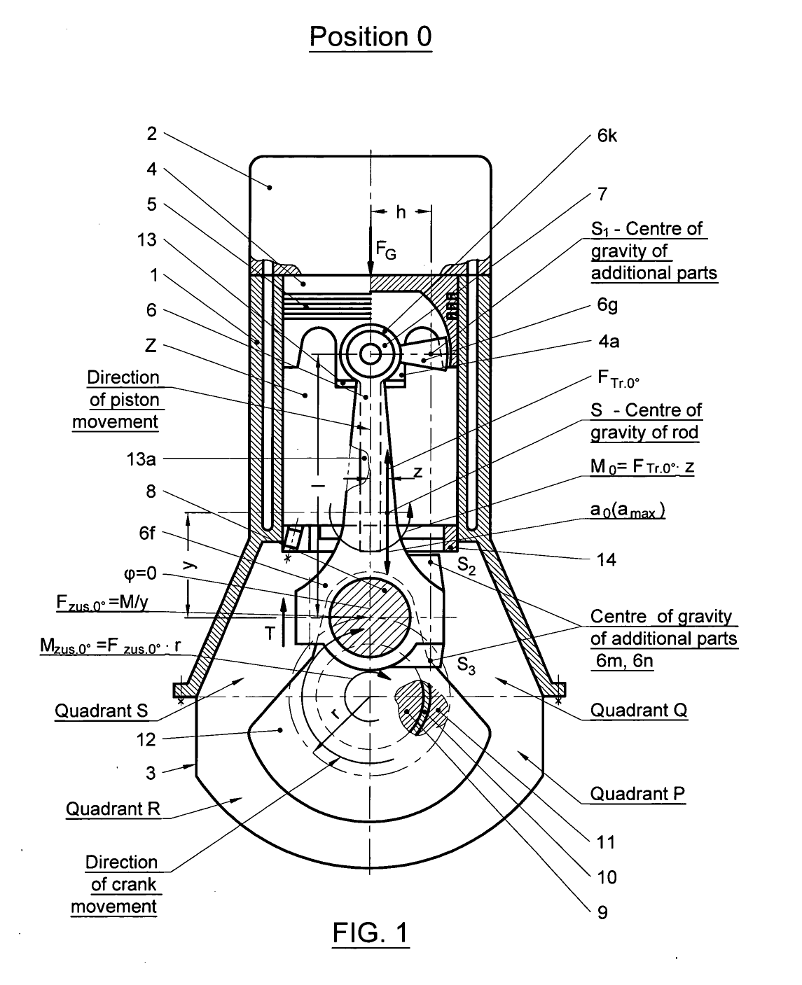

FIG. 1: A cross section of an internal-combustion engine with the additional parts to the right of the small and big ends of the piston rod and with the forced-stabilization part of the piston axle at position 0 of the piston.

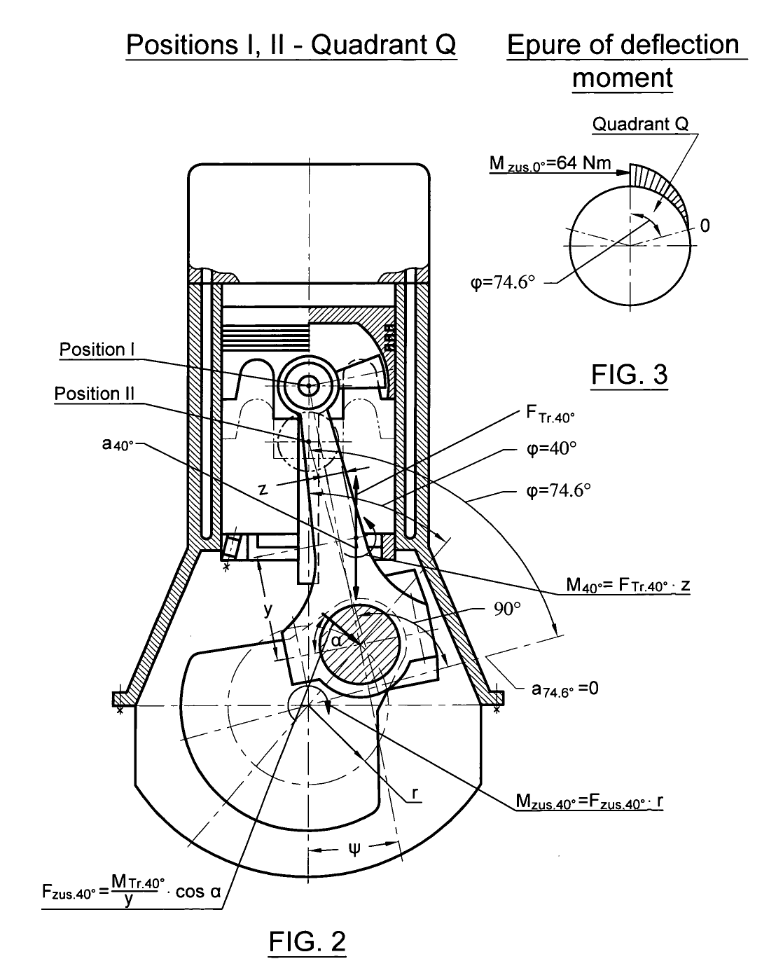

FIG. 2: The cross section at positions I, II of the piston; the crank is located in quadrant Q.

FIG. 3: An additional moment diagram of quadrant Q.

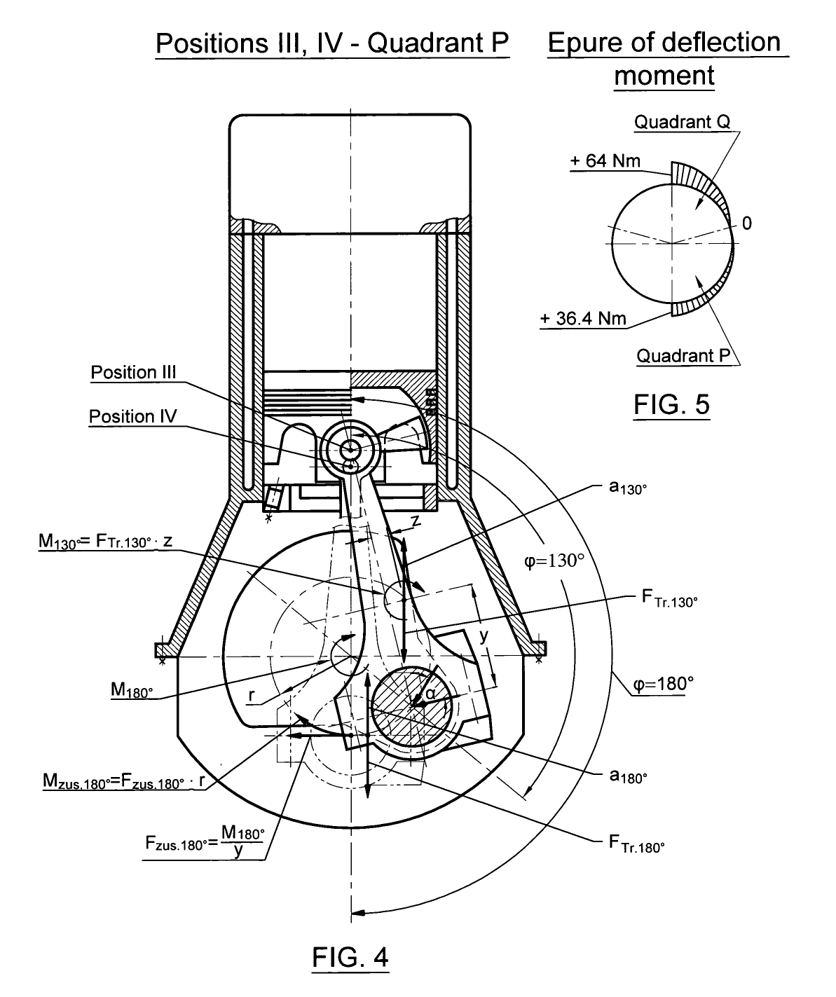

FIG. 4: The cross section at positions III, IV of the piston; the crank is located in quadrant P.

FIG. 5: Image plane of the additional moment in quadrants Q and P.

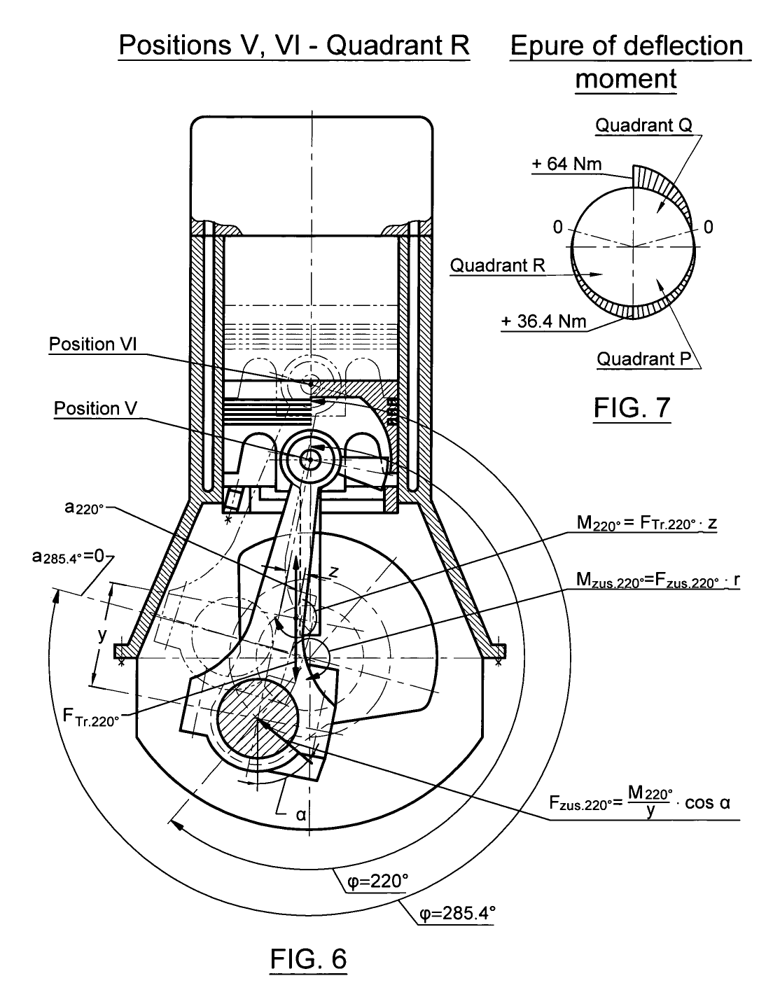

FIG. 6: The cross section at positions V, VI of the piston; the crank is located in quadrant R.

FIG. 7: Image plane of the additional moment in quadrants Q, P and R.

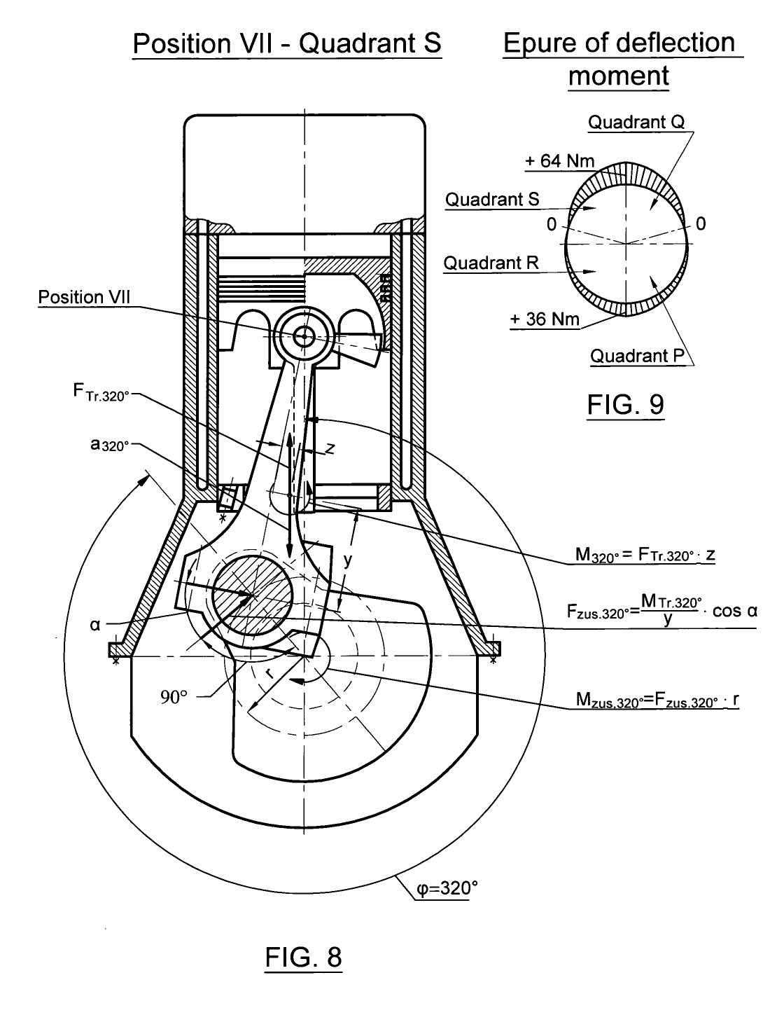

FIG. 8: The cross section in position VII of the piston; the crank is located in quadrant S.

FIG. 9: Image plane of the additional moment in quadrants Q, P, R and S.

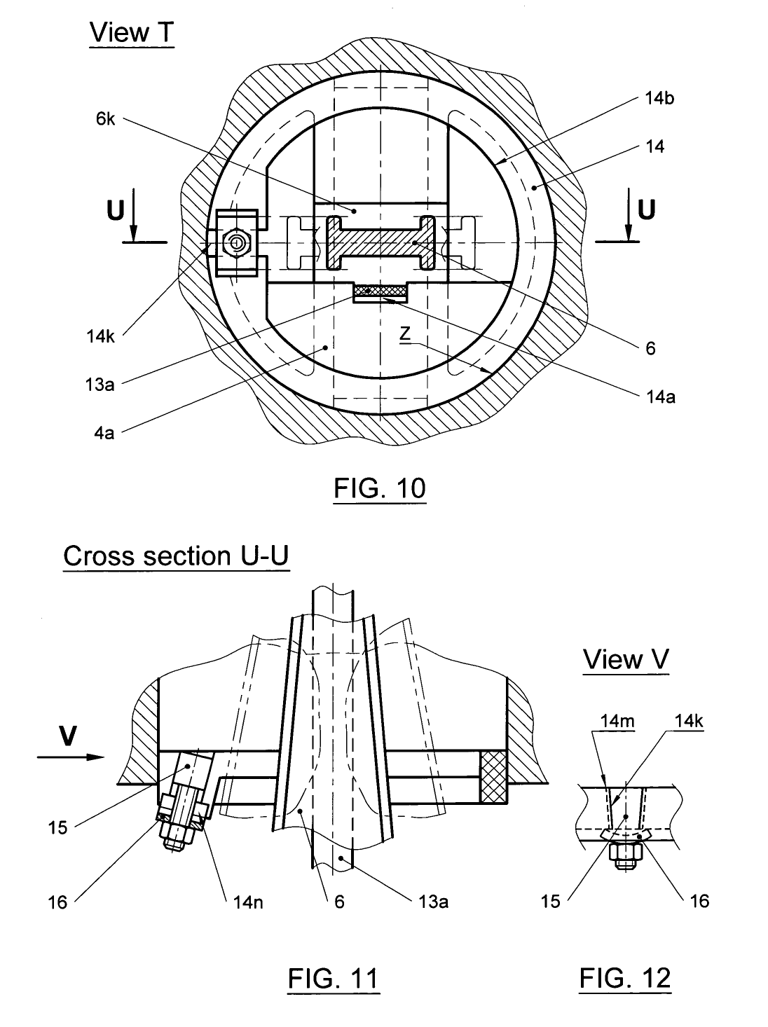

FIG. 10: A view of T as per FIG. 1: The mutual arrangement of the cylinder, the beam with the guide slot, the guide rail in the slot, the piston rod, the small end, the crank and the weights at the crank shaft.

FIG. 11: Section U-U as per FIG. 6: The arrangement of the piston rods in the opening of the beam.

FIG. 12: A view of V as per FIG. 7: The bridging of the guide beam for its attachment to the cylinder using a special screw.

The internal-combustion engine consists of the cylinder block (1) with the cylinders (Z), the cylinder head (2) and the oil pan (3). The cylinder (Z) contains the piston (4) with the compression and oil-sealing rings (5). The pistons (4) are connected with the cranks (8) of the crank shaft (9) via the piston rod (6) and the piston pin (7). The crank shaft (9) runs in the bearings (10) with covering (11). The crank shaft has the counterbalancing weights (12). Each piston (4) has a guide rail (13a), which is mounted at a piston pin hub (4a). Each guide rail (13a) is mounted at the guide slot (14a) of the beam (14), which is mounted in the lower part of the cylinder (Z). This forced stabilization of the piston allows for a reduction of the piston skirt. It reduces the piston mass and frees up space for the installation of the beam (14). The beam (14) has a round outer surface for its coupling with the cylinder's running surface and an opening for the installation of the moving piston rod (6). The beam (14) has an incision for mounting inside the cylinder which is secured with the special screw (15), the screw nut and the multipoint socket connector (16), which is connected with a screw nut (14n) to the beam (14). Additionally, the screw axle is inclined towards the periphery for an easy installation of the beam (14). The incision (14k) is crimped (14m) to enable the fixation of the special screw (15). Details (13) and (14) may be produced from plastic material, e.g. CFK—Monocoque.

Every piston rod (6) has at its small end (6k) and big end (6f) the respective additional parts (6g), (6m) and (6n). The part (6g) in the cross-section has a trapezoid form at its junction with the small end of the piston rod to maximally remove its center of gravity from the axis of the piston pin.

The additional parts (6m) and (6n) should be placed preferably at the big end of the piston rod (6f) and its cap (11). The additional parts (6g), (6m), (6n) may either be equipped as an ensemble with the piston rod or they can be a separate assembly.

The effect of the inertial forces by the additional parts to the right of the two piston ends can be seen based on a typical internal-combustion engine, with real dimensions and parameters:
1—157 mm—the length of the piston rod;
y—60 mm—the distance between the piston rod's (6) center of gravity (S) and the center of gravity of the big end axle.
h=34 mm—the distance between the axis of the piston pin and the center of gravity of the additional parts (6g, 6m, 6n);
m_{6g}=80 g—the mass of additional part (6g);
m₆ₘ₊₆n=90 g—the mass of additional parts (6f)+(6h);
mₚₛ=600 g-0.6 kg—the piston rod's own mass.

M_{psz}=600+80+90=770 g—the entire mass of the piston rod (6) without including the calculation of the new distribution of masses;

The shift of the piston rod's center of gravity z=(80×34+90×34)/770=7.5 mm

In order to perform an analysis of its effect on the main parameters of an internal-combustion engine, it is necessary to find out the inertial forces in each quadrant—Q, P, R, S—of the crank rotation zone.

It is universally known that the inertial force F_{Tr}=−am, where a—acceleration, m—mass.

The minus sign (−) means that the direction of the inertial force's vector is opposite to the direction of the acceleration vector.

Thus, in the case of a modernization of the internal-combustion engine, it would be appropriate to calculate the original combined mass of the piston and the piston rod. This can be done by the following subdivision of the masses:

The increase of mass due to the additional part (6g) is compensated by a shortening and, hence, a lightening of the piston because of its forced stabilization;
The increase of mass of the piston rod's big end is compensated by a new distribution of masses along the piston rod.

According to the formula 13.8 from the book “Verbrennungsmotoren-Grundlagen, Verfahrenstheorie, Konstruktion” (“Internal Combustion Engines: Basics, Performance theory, Structure”) by Dr. A. Urlaub—Springer-Verlag—1995, page 366, the acceleration of the piston aₖ=dc/dt=C=rω² (cos φ+λ cos 2φ),
where r—00405 m—the radius of the crank; λ=r/1=0.275
ω—Angular velocity of the crank shaft;
φ—Turning angle of the crank shaft.
The maximum rotational speed n=6100 l/min, w=638.5 Rad/S—angular velocity
In position 0 at the beginning of the working stroke φ=0

The acceleration a₀=rω²(1+λ)=0.0405×638.5²×(l+0.275)=21051.7 m/S²

Its direction points downwards.
The piston (4) moves downwards with this acceleration effected by gas pressure. The piston rod (6) moves along with a mass of appr. 0.6 kg and with the same acceleration. The inertial force of the piston rod is F_{Tr0}=0.6×21051.7=12643 N, its direction is upwards and it corresponds to the center of gravity (S) of the piston rod. This is why the inertial force produces a torsional moment M₀=F_{Tr0}. z=12643×0.0075=94.8 Nm, which has a counterclockwise direction.

The contact of the piston rod's big end with the crank (8) causes the force Fzus.₀=Mₒ/y=94.8/0.06=1580 N.

This force produces a torsional moment at the crank shaft (9) with a clockwise direction. This is the reason for the additional principal moment of the motor.

This additional torsional moment Mzusₒ=Fzus₀^{x}r=1580×0.0405=+64 Nm.

This means, that at the beginning of the working stroke in any internal-combustion engine, which has been modernized according to the invention—and unlike all traditional motors—a substantial torsional moment, caused by inertial forces, appears.

For example, in quadrant Q, with φ=40°, the piston (4) is in position I: α

The acceleration a₄₀=rω²(cos φ+λ cos 2φ)=0.0405×638.5²×(cos 40°+0.275×cos 80°)=12647.6 m/S².

It has a downwards direction. Therefore, the inertial force F_{Tr.40}=12647.6×0.6=7588.6 N.

The torsional moment at the piston rod by this inertial force is M_{Tr.40}=F_{Tr}.z/cos Ψ40, where Ψ.—is the angle of inclination of the piston rod.

M_{Tr40}=7588.6×0.0075/0.98=58.1Nm.

The additional force F_{zug40}=M_{Tr40}×cos α/y=58.1×0.643/0.06=746.8 Nm;

(α=90°−40°=50°).
The additional torsional moment at the crank shaft

M_{zus40}=F_{zus40}×r=746.8×0.0405=+30.9 Nm. This torsional moment also has a clockwise direction. This means that this torsional moment adds up with the principal torsional moment of the motor.

Moreover, one can imagine the piston rod as a lever, which rotates around the piston axle and is connected to the crank (8).

During the movement of the piston rod (6) with the above-mentioned downward acceleration, an inertial force with an upward direction appears. This inertial force corresponds to the center of gravity (S) and therefore keeps the piston rod down. Therefore, when the big end of the piston rod makes contact with the crank (8), a force develops, which additionally works to rotate the crank in a clockwise direction. This force essentially produces an additional torsional moment by the inertial force in the crank shaft of the internal-combustion engine.

In position II, the angle between the piston rod (6) and the crank (8) is 90°. In this position, the acceleration of the piston starts a change in its direction, i.e. the acceleration in position II is null.

In quadrant P, the value of the acceleration increases from null in position II of quadrant Q to the value in position IV of the piston, when the piston rod (6) is in a vertical position. The acceleration vector's direction is upwards. This means that the direction of the inertial force's vector is downwards, i.e. the inertial force also develops a torsional moment with a clockwise direction after position II. For example, with (normal text) φ=130°, an acceleration a₁₃₀=−11859 m/S² develops, and, accordingly, the additional torsional moment is M_{zus.130}=23.1 Nm, with a clockwise direction as well.

Position IV contains the bottom dead center. There, the acceleration vector has its maximum negative value a₁₈₀=−rω²(1−λ)=−11970.6 m/S². The additional torsional moment is M_{zus.180}=+36.4 Nm, with a clockwise direction as well.

In quadrant R, the acceleration goes upwards, with a gradually decreasing value. For example, in position V of the piston, with φ=220°, the acceleration a₂₂₀=11405 m/S². The inertial force is F_{Tr.220}=6843 N. Its moment is M₂₂₀=51.3 Nm. The additional torsional moment at the piston shaft is M_{zus.220}=+34.6 Nm.

After the transition of the crank (8) in quadrant S, the acceleration value of the piston (4) and, consequently, of the piston rod (6) gradually decreases, which is reflected in the diagram of the additional torsional moments. With φ=287.6°, when the piston rod is perpendicular towards the crank (8), the acceleration a287.6=0. In the course of the further rotation of the crank, the acceleration changes its direction, and its value starts to increase. For example, the acceleration a320=12647 m/S². The additional torsional moment at the crank shaft, in position VII of the piston, is M_{zus.320}=+30.9 Nm. During further rotation of the crank shaft (9), the acceleration grows and the piston returns to its starting position—position 0—with the additional torsional moment M_{zus.40}=+64 Nm. The cycle repeats.

The interaction of the guide rail (13a) with the guide slot (14a) of the beam (14), which is attached to the lower part of the cylinder, reduces the swinging amplitude of the piston around the piston pin several times. This forced stabilization of the piston's (4) axle minimizes the losses of gas in the crankcase. Therefore, the compression is substantially increased, which increases the effective pressure and, consequently, the degree of efficiency. The reduction of the gas losses very much reduces the total amount of gases in the case, which boosts the effective pressure, and, consequently, the efficiency of the motor. The reduction of gas losses and the simultaneous reduction of the total amount of gases result in a lowered oxidation of engine oil. This correspondingly increases the engine's service life. In addition, the reduction of gases in the crankcase is beneficial for the environment, because a certain part of these gases would otherwise inevitably be released to the outside by the catalytic converter through the ventilation system of the crankcase.

The optimization of the additional part's (6g) form to the right of the small end of the piston rod and the arrangement of the additional parts (6m), (6n), also located to the right of the small end, allow for an optimal utilization of the entire piston rod's mass in all quadrants—Q, P, R, S—which considerably improves the efficient use of the inertial forces' effect. The forced stabilization of the piston axle reduces internal losses and substantially increases the effective pressure and the grade of efficiency of the motor. The optimized configuration and value of the applicable vectors in the motor help to transform the inertial forces from detrimental/resisting forces into useful forces.

Thus, the following advantages are created:

The fuel consumption and, respectively, the exhaust emission is reduced. The life cycle of motor oil is increased.
The wearing of the piston rings, the piston and the cylinder is reduced.
Less material is used for the production of any piston machine applying these technical solutions.
The accelerating ability is enhanced by the smaller moving masses, e.g. the smaller mass of the flywheel.
The ecological properties of the internal-combustion engine and of other piston machines are improved.

### Summary

An internal-combustion engine comprised of a cylinder with at least one piston (4) which is moving to and from in it, and a piston rod (6), which transforms the piston's movement to rotary motion in a crank shaft (9), and including equipment for a forcible stabilization of the piston axle. Each small end of the piston rods has an additional part (6g) at its right side, to produce an additional torsional moment with the aid of inertial forces. This part is characterized by its optimized form; the piston rod's big end (6f) includes the additional parts (6m), (6n), also at its right side; In this way, the force vectors and the torsional moment of the motor are optimized due to the effect of the inertial forces and the mass of the entire piston rod may be used to increase the inertial forces, which results in a considerable improvement of the economic and ecological properties of internal-combustion engines and other piston engines.

1. An internal-combustion engine comprised of a cylinder with at least one piston which is moving to and fro in it, and a piston rod which transforms the piston's movement to rotary motion in a crank shaft, and including an equipment a forcible stabilization of the piston axle, which should preferably be composed of a guide rail (13) connecting the piston (4) and the beam (14) with the guide slot (14a) in the lower part of the cylinder (Z). In addition, each small end of the piston rod includes an additional part to the right. These additional parts (6g) are characterized by a sectional area through the piston axle, preferably in the form of a trapezium; due to its small base area, the parts nudge the small ends of the piston rods; the big end of the piston red has the additional parts (6m), (6n) at its right side.

2. An internal-combustion engine as per claim 1,
characterized by the fact that
the special screw (15) for attaching the beam (14) has an inclination to improve the cylinder's ease of installation to the periphery; the wedge head of the special screw (15) in the section (14k) of the beam (14) is fixated with the aid of inclined slots (14m); the socket connector (16) is fixated with the aid of slot (14n).
